(19) United States
(12) Patent Application Publication
(10) Pub. No.: US 2003/0114152 A1
(43) Pub. Date: Jun. 19, 2003

(54) Wireless trickle SYNC device

(76) Inventors: Benjamin K. Gibbs, Colorado Springs, CO (US); Brian L. Fox, Colorado Springs, CO (US); Andrew B. Chow, Colorado Springs, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/026,426

(22) Filed: Dec. 18, 2001

(51) Int. Cl. H04M 3/00

(52) U.S. Cl. 455/419; 455/418; 455/557

(57) ABSTRACT

A wireless data system may transmit and receive RF signals even though a host processor may be inactive. A policy is generated during an active state of the host processor. During a powered-off state of the processor, an RF device remains active to provide RF communications in accordance with the policy and store the RF signals in a memory for retrieval when the host processor again becomes active.

### BACKGROUND

Consumers desire convenient and affordable ubiquitous access to data. Wireless connections from a PC card may provide a laptop computer with modem capabilities for downloading messages and files. Normal PC card modem devices may be inactive when removed from a laptop or when the laptop is powered down, preventing a further download of messages and files. Whereas, a computer user may access email or Internet services at the office, the on the go business traveler or mobile user often waits for connectivity.

In present portable communication products, the RF transceiver may operate when the laptop computer is powered and active, but be rendered inoperative when the computer is not powered. Thus, there is a continuing need for better ways to receive desired signals even when the computer may be in a mode that reduces power consumption.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram for a system that includes a microprocessor and a memory that may be used in a laptop computer in accordance with an embodiment on the present invention;

FIG. 2 is a side view of the laptop computer that includes a PCMCIA card slot and cards in accordance with an embodiment on the present invention; and

FIG. 3 is a flowchart illustrating some steps that may be used by the system to communicate data in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

The architecture presented in the embodiments of the invention may have applications to products in portable computing, networking, digital camera applications, wireless technology and a wide range of consumer products based on instrumentation and automotive applications. It should be further understood that the circuits disclosed herein may be used in many systems that include, by way of example only, cellular radiotelephone communication systems, Personal Communication Systems (PCS), modems, two-way radio communication systems, one-way and two-way pagers, Personal Digital Assistants (PDA's) and other hand held devices. Although not shown, the system may include a display device, a keyboard, a cursor control device, a hard copy device, or a sound sampling device when used in a computer. The specific components and configuration of the computer system may be determined by the particular applications for which the computer system may be used.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

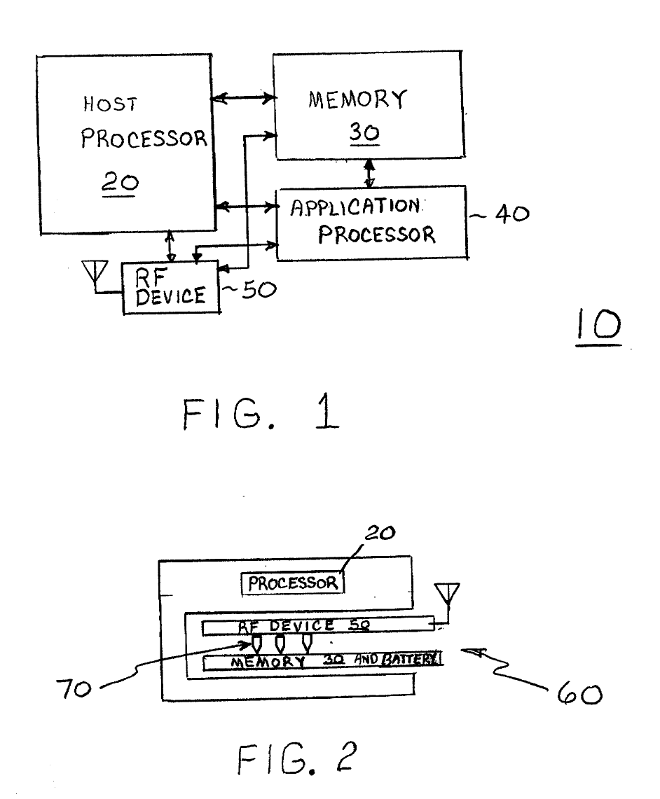

FIG. 1 is a block diagram of a system 10 for a wireless trickle sync device that may include a host processor 20. Processor 20 may be a microprocessor, a microcontroller, a Reduced Instruction Set Computing (RISC) processor, an ARM™ core from ARM Holdings in Cambridge, England, a StrongARM™ core or an XScale™ core from Intel Corporation in Santa Clara, Calif., or an embedded core, although the scope of the present invention is not limited in this respect.

System 10 may also include an application processor 40 having hardware and software specific to selected applications. As such, application processor 40 may be capable of processing functions specific to selected products. By way of example, application processor 40 may process algorithms specific to voice recognition when system 10 is part of a cellular telephone communication system. On the other hand, application processor 40 may encrypt and decrypt messages in PKI (public-key infrastructure) implementations or process algorithms to provide email system and web transaction security using, for example, the Elliptic Curve Cryptography (ECC) or the RSA encryption algorithm, named after the three mathematicians R. L. Rivest, A. Shamir, L. M. Adleman. In some embodiments, system 10 may not include an applications processor.

System 10 may include a memory 30 that may be used to store messages transmitted to or by system 10. Memory 30 may also optionally be used to store instructions that are executed by processor 20 during operation, and may be used to store user data such as the conditions for when a message may be transmitted. In various embodiments, memory 30 may represent a hard disc, a Static Random Access Memory (SRAM), a Dynamic Random Access Memory (DRAM), or a nonvolatile memory such as, for example, a ferroelectric memory or a flash memory, or a combination of these storage devices.

System 10 may also include a Radio Frequency (RF) device 50 capable of processing algorithms particular to wireless data communications and RF signaling. The radio system in RF device 50 may be specially constructed for the desired purposes or integrated and embedded to operate with other functional blocks. The modulated Radio Frequency (RF) signals received at the antenna contain information that may be recovered in a receiver portion of RF device 50. The receiver portion of RF device 50 may include Low Noise Amplifiers (LNAs), an RF mixer, a Local Oscillator (LO), and an Analog-to-Digital Converter (ADC), channel filters and a demodulator. These electrical components may be used to down convert the high frequency modulated signal to a lower Intermediate Frequency (IF) signal that may be demodulated and converted to digital values.

RF device 50 may also include a transmitter portion to transmit data from the antenna. The transmitter portion may include a Digital-to-Analog Converter (DAC), a modulator, a Local Oscillator (LO), an RF mixer, filters and power amplifiers. These electrical components may be used to convert digital values to analog signals that may be modulated and up-converted from the IF frequency range to an RF frequency range, where the modulated signal may be transmitted from the antenna.

RF device 50 may provide baseband processor capabilities to process algorithms associated with Code Division Multiple Access (CDMA), Global System for Mobile Communications (GSM), General Packet Radio Service (GPRS), North American Digital Cellular (NADC), Time Division Multiple Access (TDMA), and third generation (3G) systems like Wide-band CDMA (WCDMA), CDMA-2000, Bluetooth Special Interest Group (Bluetooth SIG), and Institute of Electrical and Electronics Engineers (IEEE) 802.11b/a, among others. It should be noted that RF device 50 may have capabilities to process data for a single algorithm or for multiple algorithms and, in general, provide the proper symbol mapping, modulation, etc. in accordance with the selected specifications.

RF device 50 may provide a high-bandwidth wireless connection to other electronic devices. As shown in FIG. 1, system 10 may wirelessly connect to other devices through one antenna, but other architecture choices may include multiple antenna in the transceiver. A multiple antenna architecture choice places one or more antenna in the receiver and transmitter portions. The multiple antenna may be placed in such a manner as to improve interference cancellation. Properly located antenna may improve the usable range of a transceiver system and aid communications through antenna diversity.

FIG. 2 is a side view of a notebook or laptop computer that illustrates an expansion board, referred to as a PCMCIA card (Personal Computer Memory Card International Association), inserted into an expansion slot in accordance with an embodiment on the present invention. Although not shown in FIG. 2, interconnect is provided to allow the transfer of signals between host processor 20, memory 30 and RF device 50. Originally designed for adding memory to portable computers, the PCMCIA standard is suitable for adding many types of devices to the portable computer. As shown in the figure, two Type II cards may be used to add RF device 50 to system 10 to communicate with processor 20 and the network. Specifically, the antenna and RF device 50 may be connected to a first Type II card that may be inserted, along with a second Type II card that includes a battery and storage expansion (memory 30), into the expansion slot. Connectors 70 may provide power conductors and electrical signal paths between the two cards. Thus, even with processor 20 powered-off, the physical connections provided by connectors 70 enable RF device 50, along with memory 30, to receive power and remain active to provide data for RF wireless communications. Alternatively, the bottom card may connect to the top card to form a Type III PC card. It is intended that the types of cards that may be plugged into the expansion slot not limit the scope of the present invention.

In operation, when host processor 20 is used in an embodiment for a laptop computer, the processor may be in either an active state or an inactive state. The active state is a powered-on state that may provide interaction between the user and processor 20. Thus, the user may supply data or other inputs to the processor that are stored or processed by processor 20 or the processor may provide outputs or processing results to the user in response to running software applications. The inactive state, on the other hand, may include a powered-off processor 20. User triggered requests for a power-down state, a sleep state or a standby state generally place the laptop computer in the inactive state. In addition, untriggered events such as, for example, a password-protected timeout of the laptop computer may place processor 20 in the inactive state. Thus, the inactive state may keep processor 20 from actively responding to data received via a keyboard, a voice recognition device, a data port, or a touch-screen device, and further, keep processor 20 from providing application results to the user. In other words, the inactive state may conserve the battery strength of the laptop computer, but also generally keeps processor 20 from being responsive to the user and to interconnected devices such as a PCMCIA card.

In an active state, host processor 20 may provide an address and interchange data through a bus connected to memory 30. Host processor 20 may also provide and receive data via an RF wireless interface connected to RF device 50. Application processor 40 may also connect through a bus to memory 30 and to RF device 50 to interchange data.

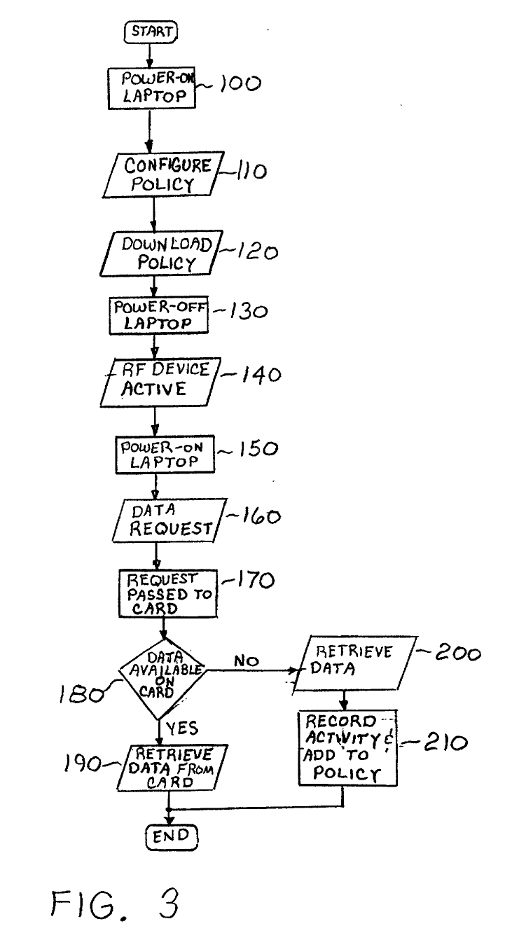

FIG. 3 is a flowchart illustrating some steps that may be used by system 10 to communicate data in accordance with an embodiment of the present invention. As apparent from the following discussions, it is appreciated that throughout the specification the invention relates to the action and/or processes of initiating wireless transmission of data, either machine data or voice data, and communicating with another electronic device when host processor 20 is inactive. Thus, with processor 20 deactivated, RF device 50 may act autonomously or separately from processor 20 to transmit and receive data in accordance with a user-defined policy.

Referring to FIGS. 1, 2 and 3, system 10 may be placed in a power-on state in step 100 that places processor 20 in the active state. With processor 20 active, the user may configure, define or write a policy in step 110. By way of example, the policy may be a set of user-defined rules in the form of a look-up table that may govern the types of data requested in a wireless communication. Thus, the policy may be a list that identifies intranet services, e-commerce services or other data-intensive services for which the user has an interest. The policy may also include user preferences, email messages, stock quotes, or user-defined web Uniform Resource Locators (URLs), etc. The policy may be used to synchronize data stored on system 10 and another computer. It should be noted that neither the types of user-defined services nor the applications listed as part of the policy are intended as limitations of the present invention.

In step 120, a file containing the policy is downloaded to RF device 50 and stored. Alternatively, the policy may be defined and written in another system and downloaded in a wireless communication to RF device 50 to be stored in memory 30. Thus, it should be noted that in accordance with embodiments of the present invention, RF device 50 may receive and store the policy information whether processor 20 is in the active state or the inactive state. With the policy downloaded to RF device 50, system 10 may be powered-off in step 130. At this point, the policy has been downloaded to RF device 50 and processor 20 may be in the inactive state.

It should be pointed out that even with processor 20 and application processor 40 in the inactive state, RF device 50 may be operable and active to initiate actions in accordance with the stored policy, and thus, RF device 50 may transmit and receive wireless communications in step 140. RF device 50 may be an “intelligent” device that may act as an intermediary or proxy between applications that may run on system 10 and the wireless network connected through the antenna to RF device 50. With processor 20 and application processor 40 inactive, RF device 50 may “preload” data from the network, replacing existing data with fresher data or preparing, in accordance with the policy, to meet the data needs of host processor 20 or application processor 40. Once host processor 20 has become active (step 150), processor 20 may request data from RF device 50 in step 160.

The request made by processor 20 may be passed to card 60 in step 170. RF device 50 may already have retrieved the data from the network that has been requested by processor 20, in which case the data is supplied to processor 20 in steps 180 and 190. If the requested data has not already been retrieved by RF device 50, then the data is retrieved and passed to processor 20 in step 200 and the policy updated in step 210.

With reference to FIG. 2, it should be noted that once card 60 has received and stored the policy, the card may be removed from the expansion slot and still remain active. In other words, RF device 50 may remain active to provide RF communications, requesting and receiving data that may be stored in memory 30. When card 60 is re-inserted into the expansion slot, processor 20 may request the data stored in memory 30.

By now it should be appreciated that a system has been presented that may deactivate the host processor but still transmit and receive data in accordance with a user-defined policy through an RF device that may act autonomously or separately from the host processor. The host processor may request data from the RF device when the processor becomes active. The RF device may save time in providing the requested data to the host processor, having used the policy to anticipate data requests, and accordingly, prepare the data in advance of the request from the host processor.

While certain features of the invention have been illustrated and described herein, many modifications, substitutions, changes, and equivalents will now occur to those skilled in the art. Examples have been provided to show embodiments of the present invention being applied to laptop or notebook computers, but other products are envisioned. The present invention is applicable to a host of products that utilize RF signaling and communications. It is, therefore, to be understood that the appended claims are intended to cover all such modifications and changes as fall within the true spirit of the invention.

1. A system, comprising:
a host processor having an active state that allows a user to specify a policy, and an inactive state where the host processor is inoperative to user inputs; and
a device coupled to the host processor to transmit and receive Radio Frequency (RF) signals in accordance with the policy when the host processor is in the inactive state.

2. The system of claim 1, wherein the inactive state of the host processor includes the host processor in one of a power-off state, a power-down state, a standby state and a sleep state.

3. The system of claim 1, wherein the policy includes at least one selected from a group that includes intranet services, e-commerce services, user preferences, email messages, stock quotes, or Uniform Resource Locators (URLs).

4. The system of claim 1, further comprising a memory coupled to the host processor and to the device.

5. The system of claim 4, wherein the memory stores data received by the device when the host processor is in the inactive state.

6. The system of claim 4, wherein the memory stores the policy.

7. The system of claim 1, where the host processor retrieves data from the device and distinguishes cached data retrieved by the host processor.

8. The system of claim 7, where the device differentiates between the cached data for age information and live data.

9. The system of claim 1, wherein the policy is defined by a user interacting with the host processor in the active state.

10. The system of claim 1 wherein the device remains powered when the host processor is inactive.

11. The system of claim 1, further including an application processor having a bus coupled to the host processor.

12. A portable system, comprising:
a host processor having an active state to generate a policy and an inactive state where the host processor in not responsive to user inputs; and
an RF device attached to a card to insert into a slot of the portable system, wherein the RF device after insertion into the slot is coupled to the host processor to receive the policy and transmit and receive Radio Frequency (RF) signals in accordance with the policy when the host processor is in the inactive state.

13. The portable system of claim 12, wherein the RF device transmits and receives RF signals in accordance with the policy when the card is detached from the portable system.

14. The portable system of claim 12, wherein the card is a PCMCIA card.

15. The portable system of claim 14, wherein the PCMCIA card is a Type II PC card.

16. The portable system of claim 12, wherein the RF device receives a policy to communicate with the host processor and change to the active state according to a completion of transmission or reception of data.

17. A portable computer having a host processor, comprising an RF device to request data in accordance with a policy that stores user-defined services in preparation of a command from the host processor to request the user-defined services.

18. The portable computer of claim 17, wherein the RF device is attached to a PCMCIA card that is inserted into a slot in the portable computer that houses the host processor.

19. The portable computer of claim 17, wherein the host processor is powered-off while the RF device requests data in accordance with the policy.

20. The portable computer of claim 17, wherein the RF device transmits and receives signals in accordance with the policy and acts autonomously from the host processor when removed from the portable computer.

21. A method, comprising:
updating a policy using a processor in a powered state;
downloading the policy to a device;
powering-off the processor; and
using the device to transmit and receive Radio Frequency (RF) signals according to the policy.

22. The method of claim 21, further comprising storing the RF signals in a memory coupled to the device.

23. The method of claim 22, further comprising providing power to place the processor in a powered-on state.

24. The method of claim 23, further comprising generating a request from the powered-on processor to receive the RF signals from the device.

25. The method of claim 23, wherein the request is passed to the device attached to a PCMCIA card that is inserted into a slot in a computer that houses the processor.

26. The method of claim 23, further comprising updating the policy with a record of activity between the processor and the device.

27. A method, comprising:
updating a policy using a processor in a portable device;
downloading the policy to an RF device that is coupled the portable device;
detaching the RF device from the portable device; and
using the RF device to transmit and receive Radio Frequency (RF) signals according to the policy.

28. The method of claim 27, further comprising providing power to the RF device through connectors to a battery in a PCMCIA card.

29. The method of claim 27, further comprising storing data for the RF signals in a memory coupled to the RF device.

30. The method of claim 29, further comprising coupling the RF device to the portable device to provide the data to the processor.
